(19) United States
(12) Patent Application Publication
(10) Pub. No.: US 2013/0036248 A1
(43) Pub. Date: Feb. 7, 2013

(54) MONITOR WITH PERSONAL SYSTEM/2 KEYBOARD INTERFACE

(71) Applicant: HAI-QING ZHOU, Shenzhen City (CN)

(72) Inventor: HAI-QING ZHOU, Shenzhen City (CN)

(73) Assignees: HON HAI PRECISION INDUSTRY CO., LTD., Tu-Cheng (TW); HONG FU JIN PRECISION INDSUTRY (ShenZhen( CO., LTD., Shenzhen City (CN)

(21) Appl. No.: 13/211,328

(22) Filed: Aug. 17, 2011

(30) Foreign Application Priority Data
Aug. 4, 2011 (CN) 201110222006.X

(51) Int. Cl. G06F 13/36

(52) U.S. Cl. 710/306

(57) ABSTRACT

A monitor for a computer includes a display screen, a frame fixing the display screen, a display circuit, a personal system (PS)/2 keyboard interface, a power circuit, and a monitor video interface. The PS/2 keyboard interface is disposed on the frame, and includes a data signal pin, a clock signal pin, a power pin, and a ground pin. The power circuit powers the display circuit and the PS/2 keyboard interface. The monitor video interface includes video pins, first and second idle pins. The video pins are connected to the display circuit. The first idle pin is connected to the data signal pin. The second idle pin is connected to the clock signal pin.

### BACKGROUND

1. Technical Field

The present disclosure relates to a monitor having a personal system/2 keyboard interface.

2. Description of Related Art

Nowadays, computer monitors only function as a display means. Thus, a monitor with more functions is needed.

### BRIEF DESCRIPTION OF THE DRAWINGS

Many aspects of the present embodiments can be better understood with reference to the following drawings. The components in the drawing are not necessarily drawn to scale, the emphasis instead being placed upon clearly illustrating the principles of the present disclosure. Moreover, in the drawing, all the views are schematic, and like reference numerals designate corresponding parts throughout the several views.

FIG. 1 is a schematic view of an exemplary embodiment of a monitor with a personal system (PS)/2 keyboard interface.

FIG. 2 is a diagram of connections between the monitor of FIG. 1 and a motherboard of a computer.

### DETAILED DESCRIPTION

The disclosure, including the accompanying drawings in which like references indicate similar elements, is illustrated by way of example and not by way of limitation. It should be noted that references to “an” or “one” embodiment in this disclosure are not necessarily to the same embodiment, and such references mean at least one.

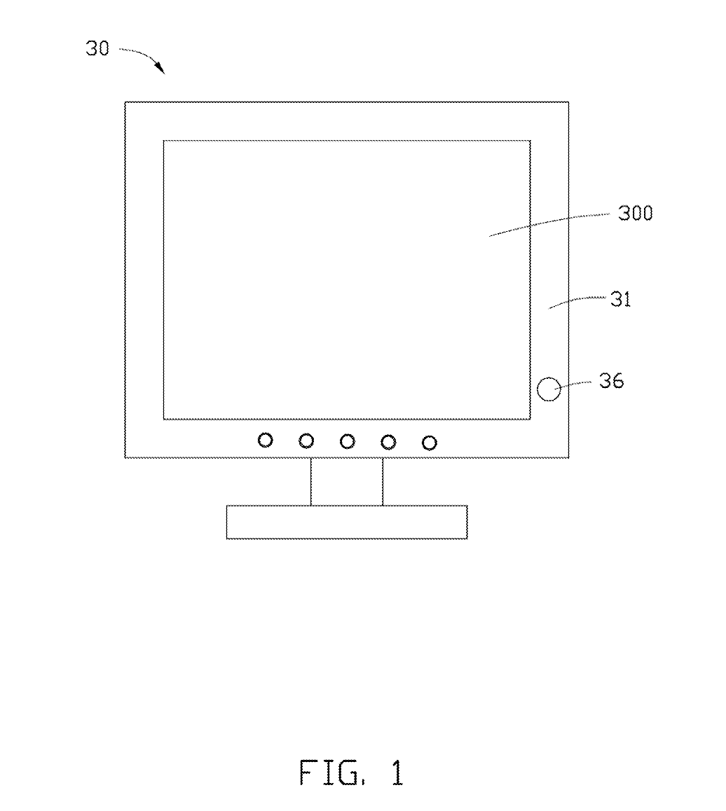

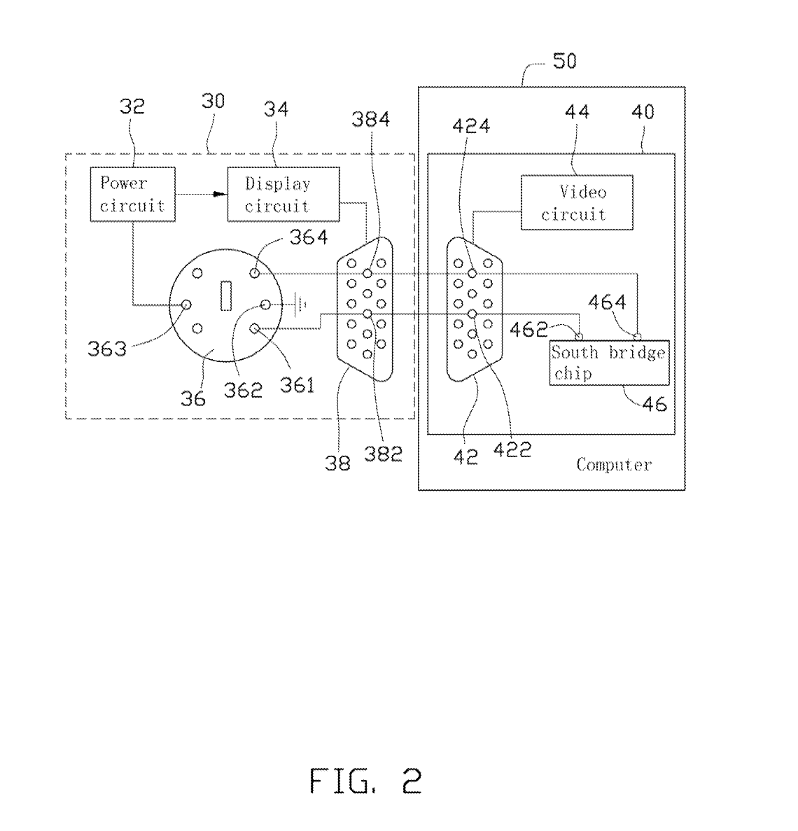

Referring to FIGS. 1 and 2, an embodiment of a monitor 30 includes a display screen 300, a personal system (PS)/2 keyboard interface 36, a power circuit 32, a display circuit 34, and a monitor video interface such as a video graphics array (VGA) interface 38.

The PS/2 keyboard interface 36 is mounted on a right side of a frame 31 fixing the display screen 300. The power circuit 32 and the display circuit 34 are set on a circuit board (not shown) of the monitor 30. The power circuit 32 is connected to the display circuit 34 to power the display circuit 34. The monitor VGA interface 38 includes a first idle pin 382, a second idle pin 384, and a plurality of video pins. The video pins are connected to the display circuit 34.

The PS/2 keyboard interface 36 includes a data signal pin 361, a ground signal pin 362, a power signal pin 363, and a clock signal pin 364. The power signal pin 363 is connected to the power circuit 32 to receive a work voltage. The ground signal pin 362 is grounded. The data signal pin 361 is connected to the first idle pin 382 of the VGA interface 38. The clock signal pin 364 is connected to the second idle pin 384 of the VGA interface 38.

A motherboard 40 of a computer 50 includes a motherboard video interface such as a VGA interface 42, a video circuit 44, and a south bridge chip 46. The south bridge chip 46 includes a keyboard data signal pin 462 and a keyboard clock signal pin 464. The motherboard VGA interface 42 includes a third idle pin 422, a fourth idle pin 424, and a plurality of video pins. The third idle pin 422 is connected to the keyboard data signal pin 426 of the south bridge chip 46. The fourth idle pin 424 is connected to the keyboard clock signal pin 464 of the south bridge chip 46. The video pins are connected to the video circuit 44.

In use, the monitor VGA interface 38 is plugged into the motherboard VGA interface 42. The third idle pin 422 of the motherboard VGA interface 42 is connected to the first idle pin 382 of the monitor VGA interface 38. The fourth idle pin 424 of the motherboard VGA interface 42 is connected to the second idle pin 384 of the monitor VGA interface 38. The data signal pin 361 of the PS/2 keyboard interface 36 is connected to the keyboard data signal pin 462 of the south bridge chip 46 through the first and third idle pins 382 and 422. The clock signal pin 364 of the PS/2 keyboard interface 36 is connected to the keyboard clock signal pin 464 of the south bridge chip 46 through the second and fourth idle pins 384 and 424. At this time, the video pins of the monitor VGA interface 38 are connected to the corresponding video pins of the motherboard VGA 42. The power circuit 32 converts alternating current (AC) power into 12 volt (V) direct current (DC) and 5V DC. The 12V DC power is provided to the display circuit 34, and the 5V DC power is provided to the PS/2 keyboard interface 36. When a PS/2 keyboard is inserted into the PS/2 keyboard interface 36, the PS/2 keyboard can communicate with the south bridge chip 46 of the motherboard 40 through the monitor VGA interface 38 and the motherboard VGA interface 42.

In other embodiments, the PS/2 keyboard interface 36 can be mounted at another position on the frame 31 of the monitor 30.

Although numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the embodiments to the full extent indicated by the broad general meaning of the terms in which the appended claims are expressed.

What is claimed is:

1. A monitor for a computer, the monitor comprising:
a display screen;
a frame fixing the display screen;
a display circuit to control the display screen;
a personal system (PS)/2 keyboard interface disposed on the frame, and comprising a data signal pin, a clock signal pin, a power pin, and a ground pin;
a power circuit connected to the display circuit to power the display circuit, and connected to the power pin to power the PS/2 keyboard interface; and
a monitor video interface mating with a motherboard video interface of the computer, the monitor video interface comprising a plurality of video pins connected to the display circuit, a first idle pin connected between the data signal pin of the PS/2 keyboard interface and a second idle pin of the motherboard video interface which is connected to a keyboard data signal pin of a south bridge chip of the motherboard, and a third idle pin connected between the clock signal pin of the PS/2 keyboard interface and a fourth idle pin of the motherboard video interface which is connected to a keyboard clock signal pin of the south bridge chip.

2. The monitor as claimed in claim 1, wherein the monitor video interface is a monitor video graphics array (VGA) interface.

3. An assembly comprising:
a monitor comprising:
a display screen;
a frame fixing the display screen;
a display circuit to control the display screen;
a personal system (PS)/2 keyboard interface disposed on the frame, comprising a data signal pin, a clock signal pin, a power pin, and a ground pin;
a power circuit connected to the display circuit to power the display circuit, and connected to the power pin to power the PS/2 keyboard interface; and
a monitor video interface comprising a plurality of first video signal pins connected to the display circuit, a first idle pin connected to the data signal pin of the PS/2 keyboard interface, and a second idle pin connected to the clock signal pin of the PS/2 keyboard interface; and
a computer comprising a motherboard, wherein the motherboard comprising:
a video circuit to provide video signals to the monitor;
a south bridge chip comprising a keyboard data signal pin and a keyboard clock signal pin; and
a motherboard video interface mating with the monitor video interface, the motherboard video interface comprising a plurality of second video signal pins connected to the video circuit, a third idle pin connected to the keyboard data signal pin of the south bridge chip, and a fourth idle pin connected to the keyboard clock signal pin of the south bridge chip;
wherein when the monitor video interface is plugged into the motherboard video interface, the first video signal pins are connected to the second video signal pins, the first idle pin is connected to the third idle pin, and the second idle pin is connected to the fourth idle pin.

4. The assembly as claimed in claim 3, wherein the monitor video interface is a video graphics array (VGA) interface, and the motherboard video interface is a VGA interface.
